(19) United States
(12) Patent Application Publication
(10) Pub. No.: US 2022/0413550 A1
(43) Pub. Date: Dec. 29, 2022

(54) APPARATUSES TO SELECTIVELY SUPPORT ELECTONIC DEVICES IN FIRST AND SECOND ORIENTATIONS

(71) Applicant: Hewlett-Packard Development Company, L.P., Spring, TX (US)

(72) Inventor: Chin-Hung HUANG, Taipei City (TW)

(73) Assignee: Hewlett-Packard Development Company, L.P., Spring, TX (US)

(21) Appl. No.: 17/362,678

(22) Filed: Jun. 29, 2021

(51) Int. Cl. G06F 1/16

(52) U.S. Cl. CPC G06F 1/1616; G06F 1/1607; G06F 1/1626; G06F 1/1681; G06F 2200/1614; G06F 2200/1613

(57) ABSTRACT

According to examples, an apparatus may include a base plate to be coupled to an electronic device, a first movable plate, and a second movable plate. The base plate may include a first edge that may extend in a first direction and a second edge that may extend from the first edge in a second direction that is different than the first direction. The first edge may be disposed adjacent to the second edge. The first movable plate may be rotatably coupled to the first edge of the base plate to selectively support the electronic device in a first orientation. The second movable plate may be rotatably coupled to the second edge of the base plate to selectively support the electronic device in a second orientation.

### BACKGROUND

Stands may be attached to electronic devices to support the electronic devices. The electronic devices may be portable electronic devices, and the stands may support the portable electronic devices in a predetermined orientation.

### BRIEF DESCRIPTION OF THE DRAWINGS

Features of the present disclosure are illustrated by way of example and not limited in the following figure(s), in which like numerals indicate like elements, in which:

FIG. 1A shows a perspective view of an example apparatus that may include a base plate to be coupled to an electronic device, a first movable plate rotatably coupled to a first edge of the base plate, and a second movable plate rotatably coupled to a second edge of the base plate;

FIG. 1B depicts an exploded perspective view of the example apparatus depicted in FIG. 1A;

FIG. 2A depicts a perspective view of an example stand, which may include a base, a first leg rotatably coupled to the base, and a second leg rotatably coupled to the base, in a landscape orientation;

FIG. 2B depicts a perspective view of the example stand depicted in FIG. 2A in a portrait orientation;

FIG. 3A depicts a rear perspective view of an example electronic device having a stand, in which the example electronic device is positioned in a first orientation;

FIG. 3B depicts a front perspective view of the example electronic device having the stand as depicted in FIG. 3A, in which the example electronic device is positioned in the first orientation;

FIG. 3C depicts a rear perspective view of the example electronic device having the stand as depicted in FIG. 3A, in which the example electronic device is positioned in a second orientation; and

FIG. 3D depicts a front perspective view of the example electronic device having the stand as depicted in FIG. 3A, in which the example electronic device is positioned in the second orientation.

### DETAILED DESCRIPTION

For simplicity and illustrative purposes, the present disclosure is described by referring mainly to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Throughout the present disclosure, the terms “a” and “an” are intended to denote at least one of a particular element. As used herein, the term “includes” means includes but not limited to, the term “including” means including but not limited to. The term “based on” means based at least in part on.

Stands may be attached to electronic devices, such as tablet computers, smart phones, and/or the like, to support the electronic devices. The stands may include a leg, which may be extended to support the electronic devices in a predetermined orientation, such as in a landscape orientation. In some examples, the same leg that is used for supporting the electronic devices in the landscape orientation may be used to support the electronic devices in a portrait orientation. In many instances, when the same leg is used for both the landscape orientation and the portrait orientation, when in the portrait orientation, the electronic device may be too upright, which may make the electronic device relatively unstable. In some examples, a side edge of the leg may be angled to accommodate use of the leg for the landscape orientation in the portrait orientation. However, in many of these instances, the leg may not provide sufficient support and the angle at which the leg is angled may be fixed, rather than being adjustable, which may limit the viewing angles in the portrait orientation.

Disclosed herein are apparatuses that may support electronic devices, such as tablet computers, mobile phones, and/or the like, in multiple orientations and/or at various angles. In some examples, the apparatus may include a base plate, a first movable plate rotatably coupled to the base plate, and a second movable plate rotatably coupled to the base plate. The base plate, which may be coupled to the electronic device, may include a first edge that extends in a first direction, and a second edge that extends from the first edge in a second direction that is different than the first direction. The first edge may be disposed adjacent to the second edge. In some examples, the first movable plate and the second movable plate may be removably coupled to the electronic device. The first movable plate may be rotatably coupled to the first edge of the base plate, and the second movable plate to be rotatably coupled to the second edge of the base plate.

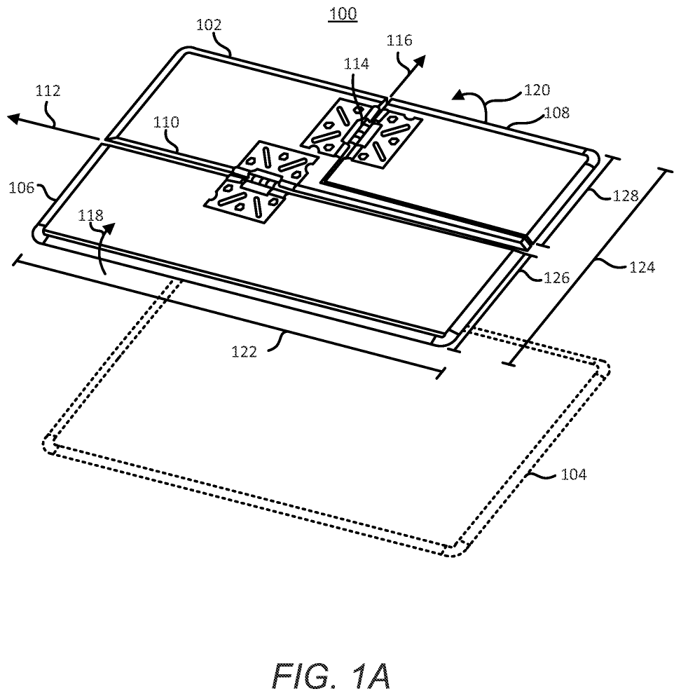

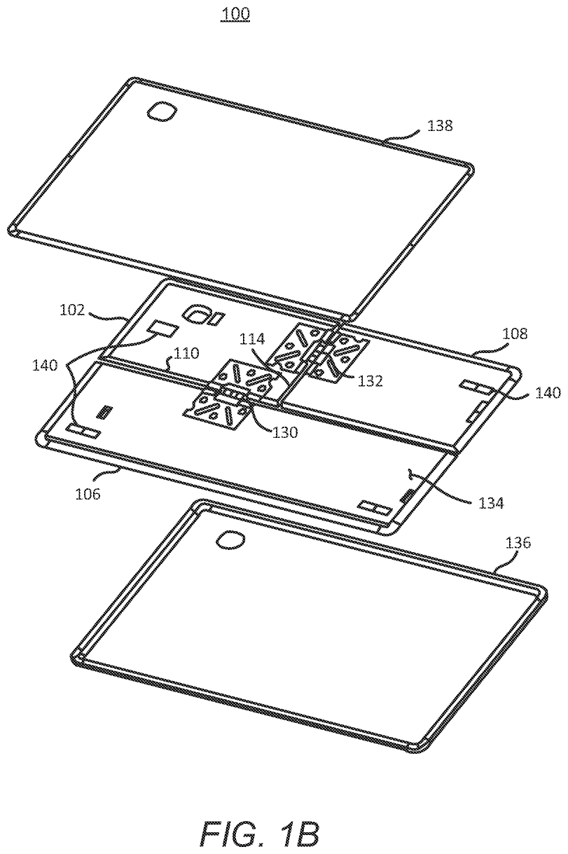

Reference is first made to FIGS. 1A and 1B. FIG. 1A shows a perspective view of an example apparatus 100 that may include a base plate 102 to be coupled to an electronic device 104, a first movable plate 106 rotatably coupled to a first edge 110 of the base plate 102, and a second movable plate 108 rotatably coupled to a second edge 114 of the base plate 102. FIG. 1B shows an exploded perspective view of the example apparatus 100 depicted in FIG. 1A. It should be understood that the apparatus 100 depicted in FIGS. 1A and 1B may include additional features and that some of the features described herein may be removed and/or modified without departing from the scope of the apparatus 100.

The apparatus 100 may include the base plate 102 to be removably coupled to the electronic device 104. The base plate 102 may include the first edge 110 that may extend in a first direction, as depicted by arrow 112, and a second edge 114 that may extend in a second direction that is different than the first direction, as depicted by arrow 116. The first edge 110 may be disposed adjacent to the second edge 114. In some examples, the base plate 102 may have a quadrilateral shape, such as a rectangular shape, a square shape, and/or the like, and the first edge 110 and the second edge 114 may be adjacent sides of the quadrilateral shape.

The apparatus 100 may include the first movable plate 106, which may be removably coupled to the electronic device 104. The first movable plate 106 may be rotatably coupled to the first edge 110 of the base plate 102. The apparatus 100 may include the second movable plate 108, which may be removably coupled to the electronic device 104 and positioned adjacent to the base plate 102 and the first movable plate 106. The second movable plate 108 may be rotatably coupled to the second edge 114 of the base plate 102.

The first edge 110, which may extend in the first direction, may be perpendicular to the second edge 114, which may extend in the second direction. The first movable plate 106 may rotate about a first axis that may extend along the first edge 110 in the first direction depicted by the arrow 112. The first movable plate 106 may rotate about the first axis in a direction depicted by arrow 118 in FIG. 1A. The second movable plate 108 may rotate about a second axis that may extend along the second edge 114 in the second direction depicted by arrow 116. The second movable plate 108 may rotate about the second axis in a direction depicted by arrow 120 in FIG. 1A.

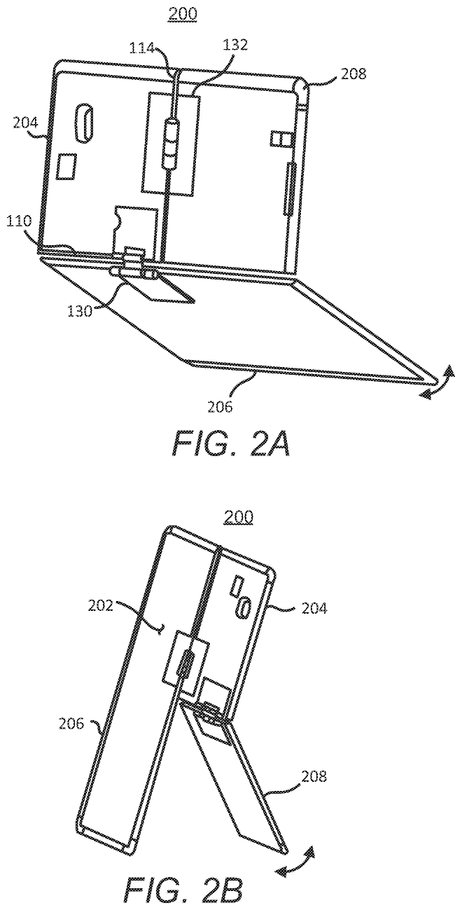

The first movable plate 106 may rotatably extend away from the electronic device 104 to support the electronic device 104, for instance, in a landscape orientation (FIG. 2A). The second movable plate 208 may rotatably extend away from the electronic device 104 to support the electronic device 104, for instance, in a portrait orientation (FIG. 2B).

In some examples, the base plate 102 may extend approximately to a midpoint along a length 122 of the apparatus 100. The second movable plate 108 may extend from approximately the midpoint to an end of the apparatus 100. A sum of the length of the base plate 102 and the length of the second movable plate 108 may correlate to the length 122 of the apparatus 100 and the electronic device 104. In some examples, the first movable plate 106 may have a length that extends a length of the apparatus 100. The length of the first movable plate 106 may correlate with the length 122 of the electronic device 104. In some examples, a sum of a width 126 of the first movable plate 106 and a width 128 of the second movable plate 108 may extend a width of the apparatus 100. The sum of the width 126 and the width 128 may correlate with the width 124 of the electronic device 104.

By way of particular example and for purposes of illustration, the base plate 102, the first movable plate 106, and the second movable plate 108 may have quadrilateral shapes, such as rectangular shapes. In these instances, in a closed state in which the first movable plate 106 and the second movable plate 108 are retracted such that they are coplanar with the base plate 102, the apparatus 100 may have a shape that correlates to a shape of the electronic device 104. In some examples, the apparatus 100 may be formed as a cover that may fit over the body of the electronic device 104 to cover the back and a side of the electronic device 104.

In some examples, the apparatus 100 may include a first hinge 130 disposed on the first edge 110 to rotatably couple the first movable plate 106 to the base plate 102. The first hinge 130 may hold the first movable plate 106 at a first certain angle with respect to the base plate 102.

In some examples, the apparatus 100 may include a second hinge 132 disposed on the second edge 114 to rotatably couple the second movable plate 108 to the base plate 102. The second hinge 132 may hold the second movable plate 108 at a second certain angle with respect to the base plate 102.

The first hinge 130 and the second hinge 132 may each have a respective mechanism that may allow the first movable plate 106 and the second movable plate 108 to be held at various angles with respect to the base plate 102 and the electronic device 104. In some examples, the first hinge 130 and the second hinge 132 may be a friction type hinge, a torque type hinge, and/or the like, which may allow control of position and movement of the first movable plate 106 and the second movable plate 108. In some examples the first hinge 130 and the second hinge 132 may have predetermined angles at which the first movable plate 106 and the second movable plate 108 may be positioned. In some examples, a plurality of the first hinge 130 or the second hinge 132 may be disposed between the base plate 102 and the first movable plate 106 and the second movable plate 108, respectively.

The base plate 102, the first movable plate 106, and the second movable plate 108 may include an inside surface 202 (FIG. 2) that may face toward the electronic device 104 and an outside surface 134 that may face away from the electronic device 104 when the base plate 102 is coupled to the electronic device 104. The apparatus 100 may include an inside cover 136 disposed to cover the inside surface 202 and/or an outside cover 138 disposed to cover the outside surface 134. In some examples, alternatively to or additionally to having the first hinge 130 and/or the second hinge 132, the inside cover 136 and/or the outside cover 138 may be fixed to the base plate 102, the first movable plate 106, and/or the second movable plate 108, and used to movably couple the base plate 102 to the first movable plate 106 and/or the second movable plate 108. In instances where the inside cover 136 and the outside cover 138 are used in lieu of the first hinge 130 and/or the second hinge 132, the inside cover 136 and the outside cover 138 may function as a hinge to movably couple the first movable plate 106 and the second movable plate 108 to the base plate 102.

The apparatus 100 may include a plurality of magnets 140 disposed on the base plate 102, the first movable plate 106, and/or the second movable plate 108. The plurality of magnets 140 may allow the base plate 102, the first movable plate 106, and/or the second movable plate 108 to be removably fixed to a back of the electronic device 104. In some examples, the plurality of magnets 140 may be positioned at predetermined positions, such as along distal edges of the first movable plate 106 and the second movable plate 108, so that a relatively greater amount of magnetic force may be applied to hold the first movable plate 106 and the second movable plate 108 when not in use. In some examples, the plurality of magnets 140 may be positioned to match up with positions of magnets and/or metallic sections disposed in the electronic device 104.

Reference is now made to FIGS. 2A and 2B. FIG. 2A depicts a perspective view of an example stand 200, which may include a base 204, a first leg 206 rotatably coupled to the base 204, and a second leg 208 rotatably coupled to the base 204, in a landscape orientation. FIG. 2B depicts a perspective view of the example stand depicted in FIG. 2A in a portrait orientation. The descriptions of the example stand 200 is made with reference to the features depicted in FIGS. 1A and 1B for purposes of illustration. It should be understood that the stand 200 may include additional features and that some of the features described herein may be removed and/or modified without departing from the scope of the stand 200.

In some examples, the stand 200 may include the base 204, which may be the same as the base plate 102 depicted in FIGS. 1A and 1B. The stand 200 may include the first leg 206, which may be the same as the first movable plate 106, and the second leg 208, which may be the same as the second movable plate 108, depicted in FIGS. 1A and 1B. The base 204 may be coupled to a back of a portable electronic device, such as the electronic device 104 depicted in FIG. 1A. In some examples, the base may have a first quadrilateral shape.

The stand 200 may include the first leg 206 rotatably coupled to the base 204 to support the portable electronic device in a landscape orientation when the first leg 206 is angled with respect to the base 204. In some examples, the first leg 206 may have a second quadrilateral shape.

The stand 200 may include the second leg 208 rotatably coupled to the base 204 to support the portable electronic device in a portrait orientation when the second leg 208 is angled with respect to the base 204. In some examples, the second leg 208 may have a third quadrilateral shape. In a closed state in which the base 204, the first leg 206, and the second leg 208 are positioned to be coplanar, the base 204, the first leg 206, and the second leg 208 may form a fourth quadrilateral shape. In this regard, the fourth quadrilateral shape may correlate to a shape of the portable electronic device.

The base 204 may extend approximately to a midpoint along a length of the stand 200. In some examples, the second leg 208 may extend from approximately the midpoint to an end of the stand 200. The first leg 206 may have a length that extends a length of the stand 200. In some examples, a sum of a width of the first leg 206 and a width of the second leg 208 may extend a width of the stand 200.

The stand 200 may include a first hinge 130 disposed on a first edge of the base 204, such as the first edge 110 depicted in FIG. 1B, to rotatably couple the first leg 206 to the base 204 to enable the first leg 206 to rotate about a first axis with respect to the base 204. The stand 200 may include a second hinge 132 disposed on a second edge of the base 204, such as the second edge 114 depicted in FIG. 1A, to rotatably couple the second leg 208 to the base 204 to enable the second leg 208 to rotate about a second axis with respect to the base 204. In some examples, the first axis and the second axis may be perpendicular to each other.

In some examples, the base 204, the first leg 206, and the second leg 208 may include an inside surface 202 that may face toward the portable electronic device and an outside surface, such as the outside surface 134 depicted in FIG. 1B, that may face away from the portable electronic device when the stand is mounted to the portable electronic device. In some examples, the stand 200 may include an inside cover disposed to cover the inside surface 202, such as the inside cover 136 depicted in FIG. 1B, and an outside cover disposed to cover the outside surface 134, such as the outside cover 138 depicted in FIG. 1B.

In some examples, the stand 200 may include a plurality of magnets, such as the plurality of magnets 140 depicted in FIG. 1B, to removably fix the stand 200 to the portable electronic device. The plurality of magnets 140 may be disposed on the base 204, the first leg 206, and the second leg 208. The plurality of magnets may removably fix the base 204, the first leg 206, and the second leg 208 to a back of the portable electronic device.

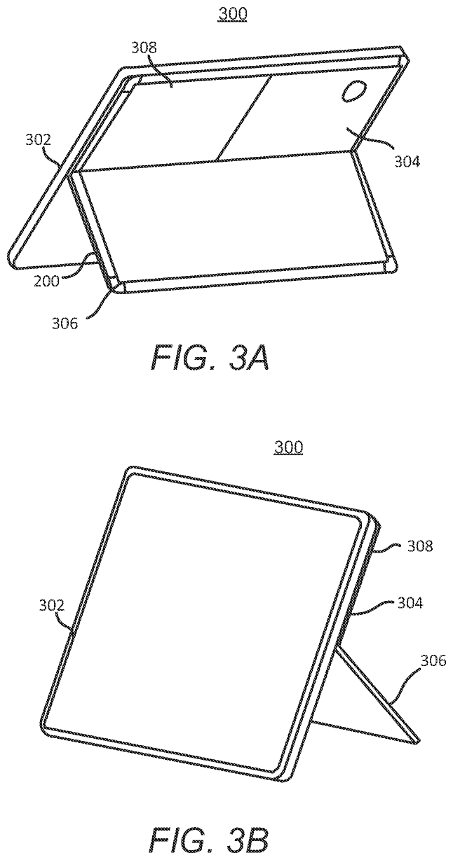

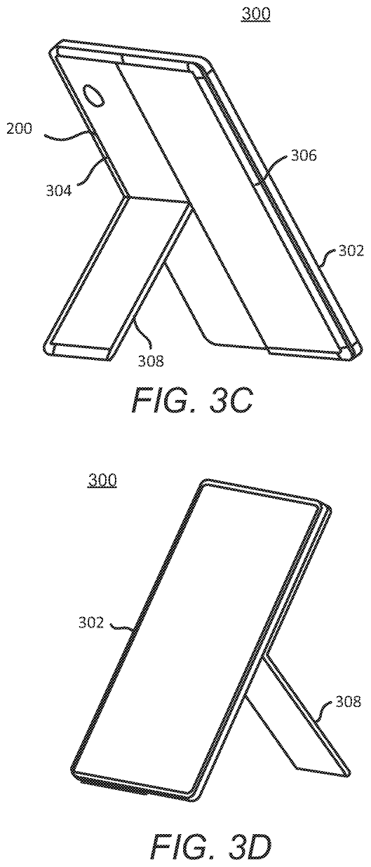

Reference is now made to FIGS. 3A-3D. FIG. 3A depicts a rear perspective view of an example electronic device 300 having a stand, such as the stand 200 depicted in FIGS. 2A and 2B, in which the example electronic device 300 is positioned in a first orientation. FIG. 3B depicts a front perspective view of the example electronic device 300 having the stand 200 as depicted in FIG. 3A, in which the example electronic device 300 is positioned in the first orientation. FIG. 3C depicts a rear perspective view of the example electronic device 300 having the stand 200 as depicted in FIG. 3A, in which the example electronic device 300 is positioned in a second orientation. FIG. 3B depicts a front perspective view of the example electronic device 300 having the stand 200 as depicted in FIG. 3A, in which the example electronic device 300 is positioned in the second orientation. The descriptions of the example electronic device 300 is made with reference to the features depicted in FIGS. 1A, 1B, 2A, and 2B for purposes of illustration. It should be understood that the electronic device 300 and/or the stand 200 may include additional features and that some of the features described herein may be removed and/or modified without departing from the scopes of the electronic device 300 and/or the stand 200.

The electronic device 300 may include a body 302 and the stand 200 removably coupled to a back of the body 302. The stand 200 may include a first cover portion 304, such as the base plate 102 depicted in FIGS. 1A and 1B, a second cover portion 306, such as the first movable plate 106 depicted in FIGS. 1A and 1B, and a third cover portion 308, such as the second movable plate 108 depicted in FIGS. 1A and 1B.

The first cover portion 304 may be removably coupled to the back of the body 302. The second cover portion 306 may be disposed adjacent to the first cover portion 304. The third cover portion 308 may be disposed adjacent to the first cover portion 304 and the second cover portion 306.

The electronic device 300 may include a first hinge, such as the first hinge 130 depicted in FIGS. 1B, 2A, and 2B, disposed between the first cover portion 304 and the second cover portion 306 to allow the second cover portion 306 to rotate about a first axis. The second cover portion 306 may support the electronic device 300 in a first orientation, such as the landscape orientation as depicted in FIGS. 3A and 3B, when the second cover portion 306 is positioned at an angle with respect to the first cover portion 304.

The electronic device 300 may include a second hinge, such as the second hinge 132 depicted in FIGS. 1B, 2A, and 2B, disposed between the first cover portion 304 and the third cover portion 308 to allow the third cover portion 308 to rotate about a second axis that is perpendicular to the first axis. The third cover portion 308 may support the electronic device 300 in a second orientation, such as a portrait orientation as depicted in FIGS. 3C and 3D, when the third cover portion 308 is positioned at an angle with respect to the first cover portion 304.

In some examples, the first cover portion 306 may extend approximately to a midpoint along a length of the stand 200 and the third cover portion 308 may extend from approximately the midpoint to an end of the stand 200. In some examples, the second cover portion 306 may have a length that extends a length of the stand 200. A sum of a width of the first cover portion 304 and a width of the second cover portion 306 may extend a width of the stand 200. In some examples, the shape of the stand 200, in which the first cover portion 304, the second cover portion 306, and the third cover portion 308 are positioned coplanar to each other, may correlate to a shape of the body 302.

In some examples, the first cover portion 304, the second cover portion 306, and the third cover portion 308 may include an inside surface that is to face toward the body 302, such as the inside surface 202 depicted in FIG. 2B, and an outside surface that is to face away from the body 302 when the first cover portion 304 is coupled to the body 302, such as the outside surface 134 depicted in FIG. 1B. The stand 200 may include an inside cover, such as the inside cover 136 depicted in FIG. 1B, disposed to cover the inside surface 202, and an outside cover, such as the outside cover 138 depicted in FIG. 1B, disposed to cover the outside surface 134.

In some examples, a plurality of first magnets, such as the plurality of magnets 140 depicted in FIG. 1B, may be disposed on the first cover portion 304, the second cover portion 306, and the third cover portion 308. The plurality of magnets may removably hold the first cover portion 304, the second cover portion 306, and the third cover portion 308 to the back of the body 302.

In some examples, a plurality of second magnets (not shown) may be disposed in the body 302 of the electronic device 300. The plurality of first magnets that may be positioned on the first cover portion 304, the second cover portion 306, and the third cover portion 308 to correlate with positions of the plurality of second magnets disposed in the body 302 of the electronic device 300.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration and are not meant as limitations. Many variations are possible within the scope of the disclosure, which is intended to be defined by the following claims—and their equivalents—in which all terms are meant in their broadest reasonable sense unless otherwise indicated.

What is claimed is:

1. An apparatus comprising:
a base plate to be coupled to an electronic device, the base plate comprising:
a first edge that extends in a first direction, and
a second edge that extends from the first edge in a second direction that is different than the first direction, the first edge being disposed adjacent to the second edge;
a first movable plate rotatably coupled to the first edge of the base plate to selectively support the electronic device in a first orientation; and
a second movable plate rotatably coupled to the second edge of the base plate to selectively support the electronic device in a second orientation.

2. The apparatus of claim 1, wherein the first direction is perpendicular to the second direction, and wherein the first movable plate is to rotate about a first axis that extends along the first edge in the first direction and the second movable plate is to rotate about a second axis that extends along the second edge in the second direction.

3. The apparatus of claim 1, wherein, when the base plate is coupled to the electronic device:
the first movable plate is to rotatably extend away from the electronic device to support the electronic device in a landscape orientation; and
the second movable plate is to rotatably extend away from the electronic device to support the electronic device in a portrait orientation.

4. The apparatus of claim 1, wherein the base plate extends approximately to a midpoint along a length of the apparatus and wherein the second movable plate extends from approximately the midpoint to an end of the apparatus.

5. The apparatus of claim 1, wherein:
the first movable plate has a length that extends a length of the apparatus, and
a sum of a width of the first movable plate and a width of the second movable plate extends a width of the apparatus.

6. The apparatus of claim 1, further comprising:
a first hinge disposed on the first edge to rotatably couple the first movable plate to the base plate, wherein the first hinge is to hold the first movable plate at a first certain angle with respect to the base plate; and
a second hinge disposed on the second edge to rotatably couple the second movable plate to the base plate, wherein the second hinge is to hold the second movable plate at a second certain angle with respect to the base plate.

7. The apparatus of claim 1, wherein the base plate, the first movable plate, and the second movable plate comprise an inside surface that is to face toward the electronic device and an outside surface that is to face away from the electronic device when the base plate is coupled to the electronic device, the apparatus further comprising:
an inside cover disposed to cover the inside surface; and
an outside cover disposed to cover the outside surface.

8. The apparatus of claim 1, further comprising:
a plurality of magnets disposed on the base plate, the first movable plate, and the second movable plate, the plurality of magnets to removably fix the base plate, the first movable plate, and the second movable plate to a back of the electronic device.

9. A stand comprising:
a base to be coupled to a back of a portable electronic device, the base having a first quadrilateral shape;
a first leg rotatably coupled to the base to support the portable electronic device in a landscape orientation when the first leg is angled with respect to the base, the first leg having a second quadrilateral shape; and
a second leg rotatably coupled to the base to support the portable electronic device in a portrait orientation when the second leg is angled with respect to the base, the second leg having a third quadrilateral shape,
wherein, in a closed state in which the base, the first leg, and the second leg are positioned to be coplanar, the base, the first leg, and the second leg form a fourth quadrilateral shape.

10. The stand of claim 9, wherein the base extends approximately to a midpoint along a length of the stand and wherein the second leg extends from approximately the midpoint to an end of the stand.

11. The stand of claim 9, wherein:
the first leg has a length that extends a length of the stand, and
a sum of a width of the first leg and a width of the second leg extends a width of the stand.

12. The stand of claim 9, further comprising:
a first hinge disposed on a first edge of the base to rotatably couple the first leg to the base to enable the first leg to rotate about a first axis with respect to the base; and
a second hinge disposed on a second edge of the base to rotatably couple the second leg to the base to enable the second leg to rotate about a second axis with respect to the base, the first axis and the second axis being perpendicular to each other.

13. The stand of claim 9, wherein the base, the first leg, and the second leg comprise an inside surface that is to face toward the portable electronic device and an outside surface that is to face away from the portable electronic device when the stand is mounted to the portable electronic device, the stand further comprising:
an inside cover disposed to cover the inside surface; and
an outside cover disposed to cover the outside surface.

14. The stand of claim 9, further comprising:
a plurality of magnets disposed on the base, the first leg, and the second leg, the plurality of magnets to removably fix the base, the first leg, and the second leg to a back of the portable electronic device.

15. An electronic device comprising:
a body;
a stand removably coupled to a back of the body, the stand comprising:
a first cover portion to be removably coupled to the back of the body;
a second cover portion disposed adjacent to the first cover portion;
a third cover portion disposed adjacent to the first cover portion and the second cover portion;
a first hinge disposed between the first cover portion and the second cover portion to allow the second cover portion to rotate about a first axis, the second cover portion to support the electronic device in a first orientation when the second cover portion is positioned at an angle with respect to the first cover portion; and
a second hinge disposed between the first cover portion and the third cover portion to allow the third cover portion to rotate about a second axis that is perpendicular to the first axis, the third cover portion to support the electronic device in a second orientation when the third cover portion is positioned at an angle with respect to the first cover portion.

16. The electronic device of claim 15, wherein the first cover portion extends approximately to a midpoint along a length of the stand and wherein the third cover portion extends from approximately the midpoint to an end of the stand.

17. The electronic device of claim 15, wherein:
the second cover portion has a length that extends a length of the stand, and
a sum of a width of the first cover portion and a width of the second cover portion extends a width of the stand.

18. The electronic device of claim 15, wherein the first cover portion, the second cover portion, and the third cover portion comprise an inside surface that is to face toward the body and an outside surface that is to face away from the body when the first cover portion is coupled to the body, the electronic device further comprising:
an inside cover disposed to cover the inside surface; and
an outside cover disposed to cover the outside surface.

19. The electronic device of claim 15, further comprising:
a plurality of first magnets disposed on the first cover portion, the second cover portion, and the third cover portion, the plurality of magnets to removably hold the first cover portion, the second cover portion, and the third cover portion to the back of the body.

20. The electronic device of claim 19, further comprising:
a plurality of second magnets disposed in the body of the electronic device, the plurality of first magnets disposed on the first cover portion, the second cover portion, and the third cover portion correlating with positions of the plurality of second magnets disposed in the body of the electronic device.
